(19) United States
(12) Patent Application Publication
(10) Pub. No.: US 2010/0068020 A1
(43) Pub. Date: Mar. 18, 2010

(54) SNOWMOBILE LOADER

(76) Inventor: Robert P. Asfeld, Beardsley, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/538,527

(22) Filed: Aug. 10, 2009

Related U.S. Application Data
(63) Continuation of application No. 11/074,592, filed on Mar. 8, 2005, now abandoned.
(60) Provisional application No. 60/551,173, filed on Mar. 8, 2004.

(51) Int. Cl. B60P 1/24

(52) U.S. Cl. 414/477; 414/812

(57) ABSTRACT

A snowmobile loader having a base having generally opposed side members and at least one cross member that is disposed between the side members, the cross member including a first portion having a first surface adapted to rest on a tailgate when the tailgate is in a down position and a second surface generally opposed the first surface, the second surface having a base roller disposed thereon and a second portion depending from the first portion, such that when the cross member rests on the tailgate the second portion prevents the tailgate portion from shifting with respect to the tailgate. The snowmobile loader further includes a ramp having a track portion and a pair of ski portions on opposing sides of the track section, the ramp being selectively engageable with the base such that the ramp is slidable on the roller between a ramp position and a transport position.

### RELATED APPLICATION

This application is a continuation of application Ser. No. 11/074,592 filed Mar. 8, 2005, which claims the benefit of U.S. Provisional Application No. 60/551,173 filed Mar. 8, 2004, each of which is hereby fully incorporated herein by reference.

### TECHNICAL FIELD

The present invention relates to recreational vehicle transporters. More particularly, the present invention relates to a transporter for use in loading and transporting a snowmobile in the bed of a pick-up truck.

### BACKGROUND OF THE INVENTION

Snowmobile users often desire to store their sleds in one location and transport them to another location to use. For example, snowmobile users often live in areas where there is no land generally available to use for snowmobiling or areas where there is not any snow-covered land. As such, the users often wish to transport their snowmobiles to those areas where there is available, snow-covered land.

When users wish to transport their snowmobiles, they often place their sleds onto a snowmobile trailer that is designed for single or multiple sleds. However, the trailers are often big and expensive and sometimes difficult to load with the snowmobiles. In addition, multi-sled trailers are often overkill when a snowmobile user simply desires to transport a single snowmobile. In these situations, it is often more desirable to place the sled into the back of a pick-up truck to transport, thus eliminating the need for hooking up and pulling a trailer.

To get the sleds into the truck bed, persons often work in tandem to lift the sleds up and into the back of the truck. This can be a cumbersome process, often resulting in damage to the snowmobiles or injury to those doing the loading. While some ramps and devices have been developed to assist in loading and transporting snowmobiles or other recreational vehicles into pick-up trucks, these devices do not meet all of the current needs of those owning and using recreational vehicles desiring to transport the vehicles. Some of these attempts require complex hydraulic mechanisms and others require significant manual force to lift the sleds into the pick-up trucks. Moreover, many of these attempts require significant permanent hardware installed onto the truck itself. Some examples of the aforementioned attempts can be seen in U.S. Pat. Nos. 6,767,171, 5,899,466, 3,837,663, and 3,687,314.

Therefore, there currently exists a need in the industry for a single person, unaided by hydraulic or other mechanical assist, to be able to readily load, unload, and transport a snowmobile in the bed of a pick-up truck. In particular, there is a need for a momentum-based snowmobile transporter in which a snowmobile can be loaded without manually or hydraulically lifting the snowmobile into the pick-up truck.

There is also a need for a lightweight snowmobile transporter that can be easily placed into and removed from the bed of a pick-up truck without permanently installing any hardware on the pick-up truck. There is also a need for a lightweight snowmobile transporter that can be placed used in one pick-up truck and easily transferred to another pick-up truck without substantial modification.

### SUMMARY OF THE INVENTION

The present invention overcomes the disadvantages and shortcomings of the prior art by providing methods and apparatuses for easily loading and transporting snowmobiles into a pick-up truck bed. The sled loader is designed to utilize the momentum of a moving snowmobile approaching the parked truck to load the snowmobile in the truck bed substantially without human or mechanical intervention so that a single person can readily load/unload a snowmobile from the pickup bed. Further, the sled loader of the present invention is not affixed in any manner to the bed or tailgate of the pick-up truck. An advantage of this is that the present sled loader does not unduly restrict other uses of the pick-up bed as the sled loader is readily removed from the pick-up bed by simply rolling the ramp out of the bed and lifting the tailgate roller unit off the pickup tailgate.

In a preferred embodiment of the present invention, the snowmobile loader includes a base including generally opposed side members and at least one cross member disposed between the side members. The cross member includes a first portion having a first surface that is adapted to rest on a tailgate when the tailgate is in a down position and a second surface that is generally opposed the first surface, the second surface having a base roller disposed thereon. The cross member also includes a second portion depending from the first portion, such that when the cross member rests on the tailgate the second portion prevents the tailgate portion from shifting with respect to the tailgate. The snowmobile loader also includes a ramp having a track portion and a pair of ski portions on opposing sides of the track section, the ramp being selectively engageable with the base such that the ramp is slidable on the roller between a ramp position and a transport position.

The snowmobile loader also preferably includes a second cross member that is disposed between the side members. The second cross member preferably includes a third portion having a third surface that is adapted to rest on a truck bed and a fourth portion depending from the third portion, such that when the second cross member rests on the truck bed the fourth portion prevents the base from shifting with respect to the truck bed. The second cross member also preferably includes a fourth surface that is generally opposed the third surface and a second base roller disposed on the fourth surface.

The snowmobile loader of the present invention also preferably includes a side roller on the side members and the ski portions include tip receivers that are disposed at a forward margin of the ski portions. The tip receivers preferably include a locking pin. In addition, it is preferred that the ski portions include a recess extending along a length of the ski portions, the recess preferably being V-shaped.

The present invention also relates to a method of loading a snowmobile into a truck bed using a sled loader including the following steps: providing a base having generally opposed side members and a cross member disposed between the side members, the cross member comprising a first portion having a base roller disposed thereon and a second portion depending from the first portion; placing the base on a truck such that the second portion extends downwardly to prevent the base from shifting forwardly or rearwardly with respect to the truck; providing a ramp having a track portion and a pair of ski portions on opposing sides of the track portion; placing the ramp in a ramp position, such that an upper end of the ramp rests on the roller and at least a portion of a lower end of the ramp rests on the ground; and advancing a snowmobile towards the sled loader at a speed sufficient to allow the snowmobile to advance upwardly on the ramp until a momentum of the snowmobile causes the ramp to pivot upon the base roller and the snowmobile and ramp to advance on the base roller until the ramp is at a transport position within the truck bed.

In a preferred embodiment, the method of loading a snowmobile includes securing the ramp to the base to prevent the ramp from moving rearwardly with respect to the base. Further, the method of loading includes securing a pair of snowmobile ski tips to respective tip receivers included on the ski portions to prevent the snowmobile from moving with respect to the ramp. Also, the method of loading includes providing at least one ramp roller on an underside of the ramp such that when the snowmobile momentum causes the ramp to pivot upon the base roller, the ramp roller comes into contact with the truck bed and advances in the truck bed until the ramp is at the transport position.

The present invention also relates to a method of manufacturing a sled loader including the steps of: forming a cross member so that it comprises a first portion having a bottom surface and a top surface and a second portion depending from the first portion; forming a first side member and a second side member; attaching the first side member to the cross member proximate a first end of the cross member and connecting the second side member to the cross member proximate a second end of the cross member, such that the cross member and first and second side members define a base and the first and second side members define a base width; attaching a base roller on the upper surface of the first portion; forming a ramp comprising a track ramp, a first ski ramp, and a second ski ramp; and connecting the track ramp and first and second ski ramps using a ramp cross member to define a ramp that is operably connectable with the base, such that the first and second ramps are on opposing sides of the track ramp and define a ramp width, the ramp width being less than the base width.

In a preferred embodiment, the method of manufacturing a sled loader includes attaching a ramp roller on an underside the ramp. Further, the method of manufacturing includes forming a notch along the length of the ski ramps. Also, the method of manufacturing includes attaching tip receivers at forward margins of the first and second ski ramps and forming retaining lips on the track ramp and ski ramps.

These and other features and advantages of the present invention will be apparent in the following detailed description of the preferred embodiments when read in conjunction with the accompanying drawings, in which like reference numerals are used to identify the same or similar parts in the several views.

### BRIEF DESCRIPTION OF THE DRAWINGS

FIG. 1 is a side view of a sled loader according to an embodiment of the present invention;

FIG. 2 is a top view of the base of the sled loader according to an embodiment of the present invention;

FIG. 3 is a side view of the base of the sled loader according to an embodiment of the present invention;

FIG. 4 is a top view of the ramp of the sled loader according to an embodiment of the present invention;

FIG. 5 is a side view of the ramp of the sled loader according to an embodiment of the present invention;

FIG. 6 is a side perspective view of the base of the sled loader according to an embodiment of the present invention;

FIG. 7 is a rear perspective view of the of the sled loader according to an embodiment of the present invention;

FIG. 8 is a right side perspective view of the of the sled loader according to an embodiment of the present invention;

FIG. 9 is a rear perspective view of the of the sled loader according to an embodiment of the present invention;

FIG. 10 is a right side perspective view of the of tip receiver of the sled loader according to an embodiment of the present invention;

FIG. 11 is a right side perspective view of the of the sled loader according to an embodiment of the present invention;

FIG. 12 is a cross-sectional view of a ski ramp according to an embodiment of the present invention; and

FIG. 13 is a cross-sectional view of a track ramp according to an embodiment of the present invention.

### DETAILED DESCRIPTION OF THE DRAWINGS

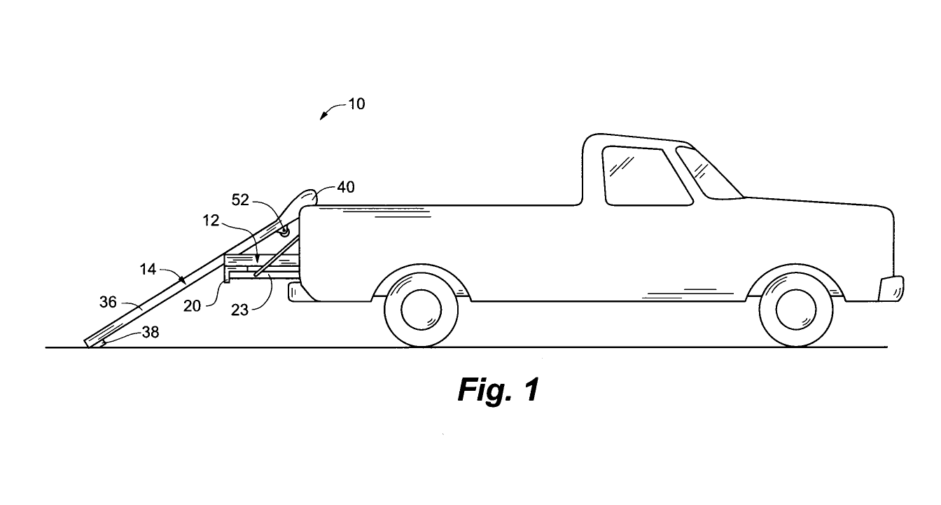

The sled loader of the present invention can be seen generally at 10 in the figures. As can be seen in FIG. 1, the sled loader 10 generally comprises a base or tailgate roller unit 12 and a ramp 14.

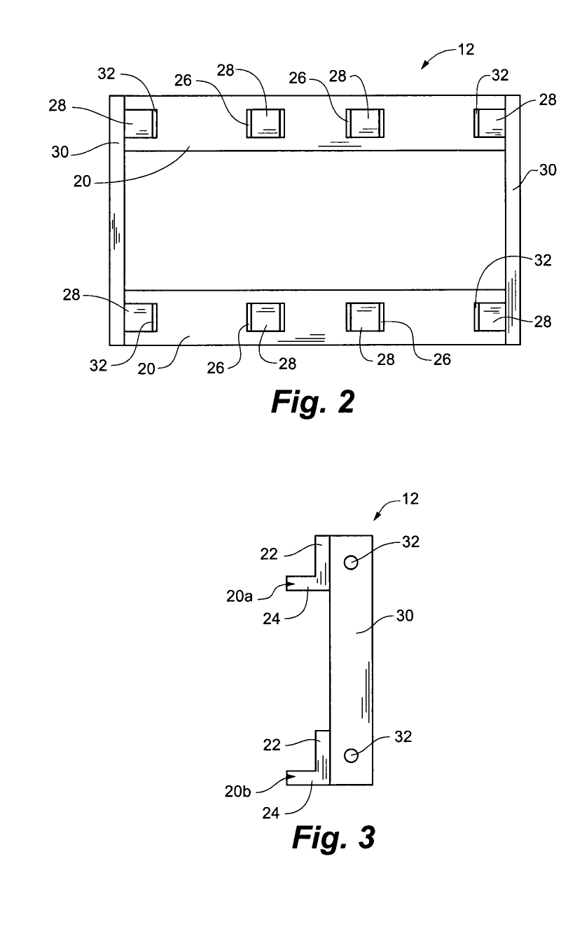

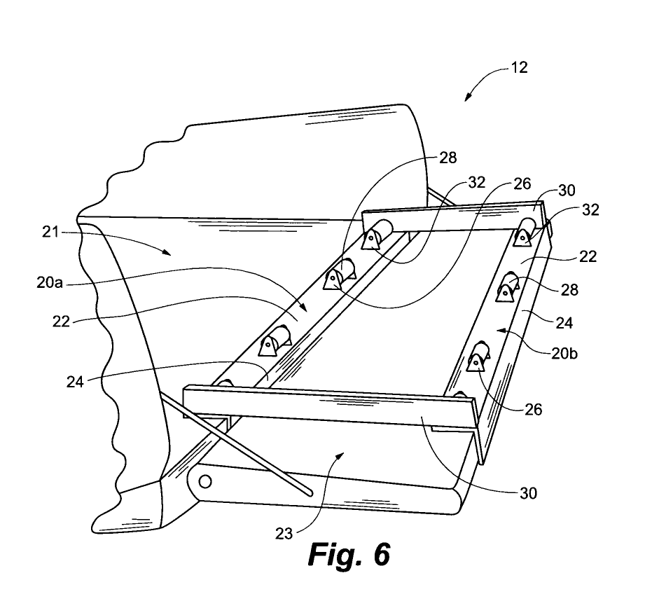

As can be seen in FIGS. 2-3, the tailgate roller unit 12 of the sled loader 10 includes a plurality of cross members 20 that are preferably L-shaped in cross-section. The cross members 20 include a relatively wide flat portion 22 that is configured to sit flat or rest on the pick-up truck near the rear end margin of the bed, as depicted in FIG. 6. The cross members 20 also include a relatively narrow flat portion 24 that depends from the relatively wide flat portion 22. In a preferred configuration, the relatively wide portion 22 and relatively narrow portion 24 are substantially at a right angle relative to each other. The term “substantially,” as used herein, means considerable in importance, value, degree, amount, or extent. The cross members 20 are preferably constructed of ⅛″ sheet steel, but can be constructed of other thicknesses or materials, such as aluminum, without departing from the scope of this invention. The cross members 20 are preferably formed of a unitary sheet of steel, thus allowing easy formation of the L-shape by bending the sheet steel.

As can be seen further in FIG. 6, when the base 12 is placed onto a tailgate 23, the depending portion 24 of the forwardmost cross member 20a projects downward into the gap between the rear end margin of the pick-up bed 21 and the leading edge of a pickup tailgate 23 when the tailgate 23 is in the down position. The depending portion 24 of the trailing cross member 20b extends downwardly alongside the rear margin of the tailgate 23 when the tailgate 23 is in the down position. When arranged in this manner, the tailgate roller unit 12 is substantially prevented from shifting either rearwardly or forwardly with relation to the pick-up truck.

The cross members 20 of tailgate roller unit 12 also preferably include at least two roller mounts 26 that are formed on or attached to the flat portion 22 of the cross members 20. Each of the roller mounts 26 supports a roller 28. In a preferred embodiment, the rollers 28 are located near the center of the cross members 20 but are spaced apart by approximately the width of a snowmobile track. The roller mounts 26 may be adjustable so that they can be widened or narrowed with ease. In other embodiments of the present invention, each of the cross members 20 of tailgate roller unit 12 include less than two roller mounts 26. The rollers 28 are preferably constructed of polyurethane, but can be constructed of other materials, such as plastic or rubber, without departing from the scope of this invention.

The tailgate roller unit 12 also preferably comprises upwardly projecting side plates 30 that are affixed to the flat portion 22 of the cross members 20 to define side margins of the tailgate roller unit 12. Each of the side plates 30 preferably includes at least two roller mounts 32, one being generally forward on the tailgate roller unit 12 proximate the forwardmost cross member 20a and the other being generally rearward on the tailgate roller unit 12 proximate the trailing cross member 20b. The roller mounts 32 each preferably support a single roller 28. The side plates 30 are preferably constructed of ⅛″ sheet steel, but can be constructed of other thicknesses or materials, such as aluminum, without departing from the scope of this invention.

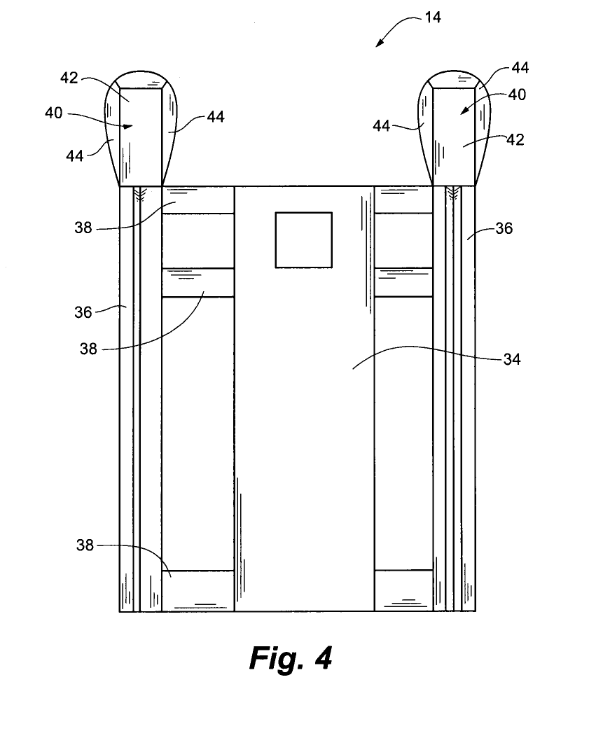

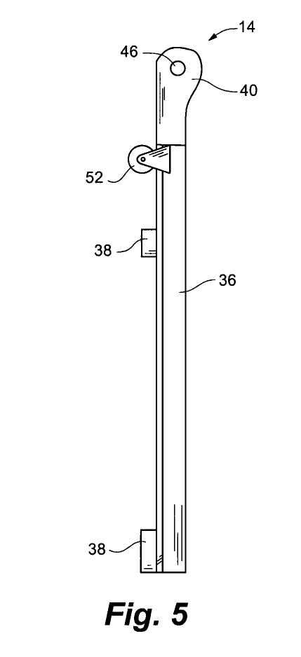

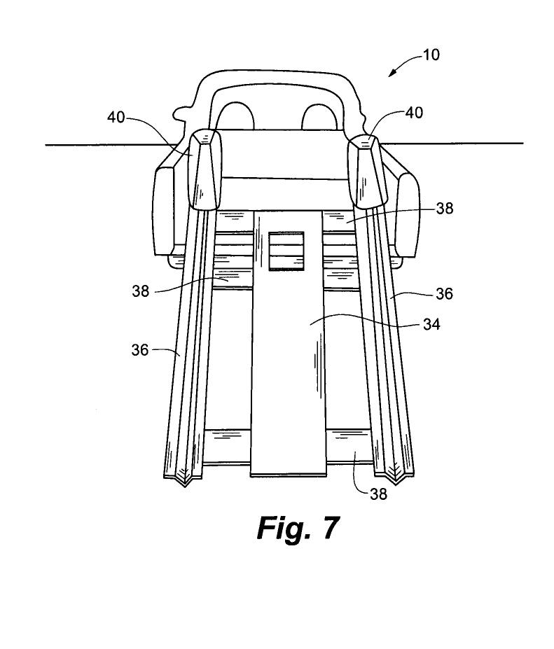

As can be seen in FIGS. 4-5, the sled loader 10 also comprises a ramp 14. In a preferred embodiment, the ramp 14 is not connected in any way to the tailgate roller unit 12 when the sled loader 12 is deployed for loading or unloading a snowmobile from a pick-up bed. In a ramp position, as can be seen in FIG. 7, a leading portion of the ramp 14 is placed on the rearward-most set of rollers 28 of the tailgate roller unit 12 while the trailing portion of the ramp 14 rest on the ground for loading and unloading.

While the ramp 14 of the sled loader 10 in the present application is generally described in its preferred embodiment in which the ramp 14 is not connected to the tailgate roller unit 12, in another embodiment of the present invention, the ramp 14 is operably connected to the tailgate roller unit 12.

The ramp 14 includes a centrally mounted track ramp 34 that preferably substantially matches the width of a snowmobile track and is slightly wider than the spacing of the rollers 28 on each cross member 20. As can be seen in FIG. 13, the track ramp 34 preferably is formed so that it includes retaining lips 35 on the edges of the track ramp.

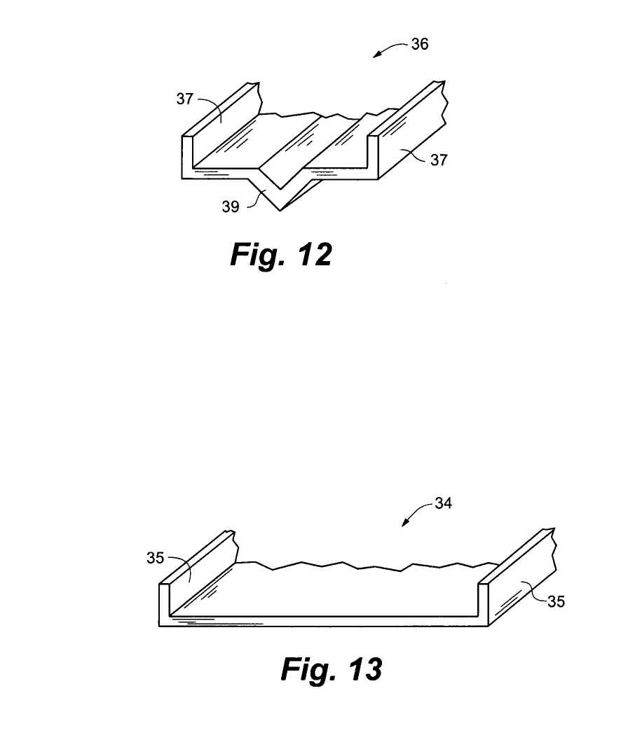

The ramp 14 also includes a generally opposed pair of ski ramps 36 disposed outwardly of the track ramp 34. The track ramp 34 and ski ramps 36 are fixed by laterally disposed cross members 38. In a preferred embodiment, three cross members 38 formed of elongated flat plates fix the track ramp 34 and ski ramps 36. The ski ramps 36 are preferably formed with a central “V” 39 as depicted in FIG. 12. The central “V” 39 accommodates and guides the carbides on the skis of the snowmobile. The ski ramps 36 are preferably slightly wider than a snowmobile ski and preferably formed to include retaining lips 37 on the edges of the ski ramps. While the ski ramps 36 are shown and described as including a central “V” 39, they could also be formed to include a “U” or other shaped notch to accommodate and guide the carbides on the skis of the snowmobile.

The ramp 14 also includes a pair of ski tip receivers 40 that project forwardly and upwardly from the forwardmost margins of the ski ramps 36. The tip receivers 40 generally include a substantially flat bottom 42 and a pair of generally opposed sides 44. The tip receivers 40 are generally shaped to receive a snowmobile ski tip.

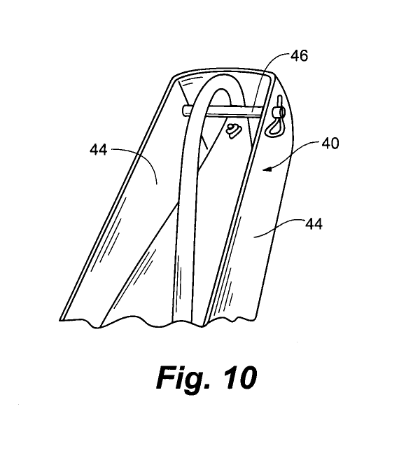

The ski tip receivers 40 preferably include a pair of generally opposed apertures that are defined in the sides 44 proximate the forward edge of the sides 44. A locking pin 46 may be disposed in the bores that can be used to secure the tip 48 of the ski of the snowmobile as depicted in FIG. 10. The locking pin 46 is preferably constructed of hardened steel, but could be constructed of other materials, such as aluminum or titanium, without departing from the scope of the invention. Alternatively, other means could be used to secure the tip 48 of the ski of the snowmobile with respect to the ramp, such as a lock or latch.

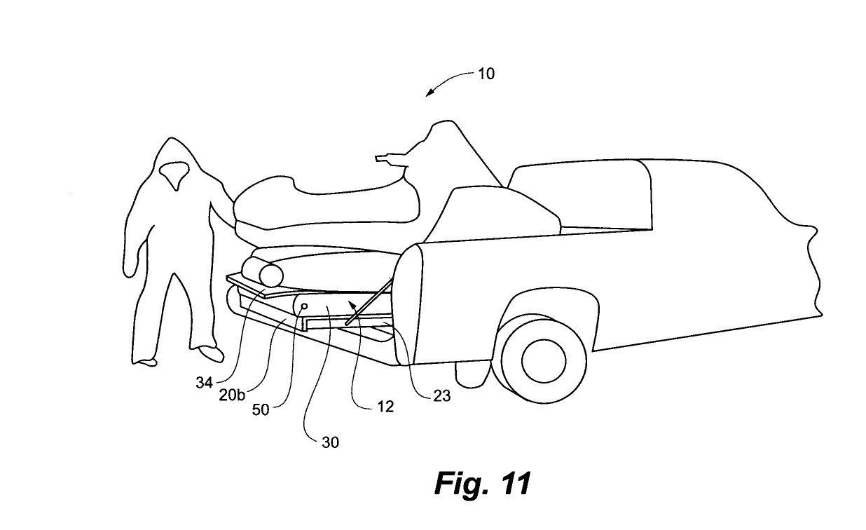

An additional ramp-locking pin 50 is depicted in FIG. 11. After a snowmobile is loaded and the snowmobile and ramp 14 are translated to their forwardmost position in the pick-up bed, the ramp 14 may be secured to the tailgate roller unit 12 by the readily removable ramp-locking pin 50. Because the tailgate roller unit 12 is substantially prevented from translating either forwardly or rearwardly relative the pick-up bed by the depending portions 24 of the cross members 20, the ramp locking pin 50 thereby prevents the ramp 14 and the snowmobile disposed thereon from translating forwardly or rearwardly during transportation. The ramp-locking pin 50 is preferably constructed of hardened steel, but could be constructed of other materials, such as aluminum or titanium, without departing from the scope of the invention. Alternatively, other means could be used to prevent the tailgate roller unit 12 from translating either forwardly or rearwardly relative the pick-up bed, such as a lock or latch.

The ramp 14 also preferably includes a pair of depending rollers 52 that are affixed to the underside of the ramp 14 proximate the forward edge of the respective ski ramps 36, as can be seen in FIGS. 1 and 5. The rollers 52 are designed to roll on the bottom of the pick-up bed during forward and rearward translation of the ramp 14 relative to the pick-up bed. The track ramp 34, ski ramps 36, cross members 38, and ski tip receivers 40 are preferably constructed of ⅛″ sheet steel, but can be constructed of other thicknesses or materials, such as aluminum, without departing from the scope of the present invention. The rollers 52 are preferably constructed of polyurethane, but can be constructed of other materials, such as plastic or rubber, without departing from the scope of this invention.

In order to load a snowmobile into the pick-up truck bed 21, the base 12 is first placed onto the truck such that the depending portion 24 on the forwardmost cross member 20a extends downwardly between the rear margin of the truck bed 21 and the forward margin of the tailgate 23 and the depending portion 24 on the rearward-most cross member 20b extends downwardly proximate a the rear margin of the tailgate 23, as can be seen in FIG. 6. Next, the upper end of the ramp 14 is placed on the rollers 28 on the rearward-most cross member 20b such that at least a portion of a lower end of the ramp 14 rests on the ground, as can be seen in FIG. 7.

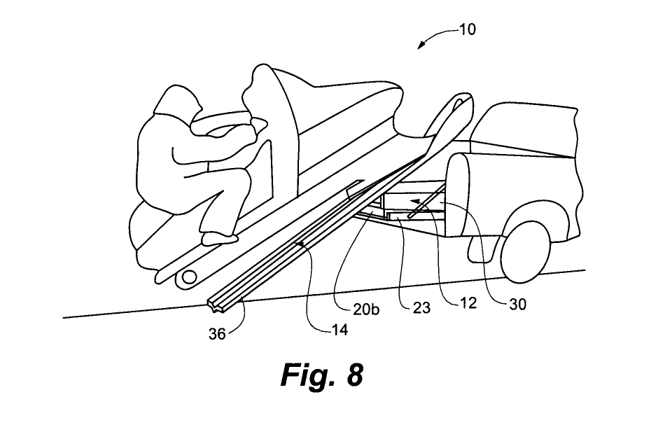

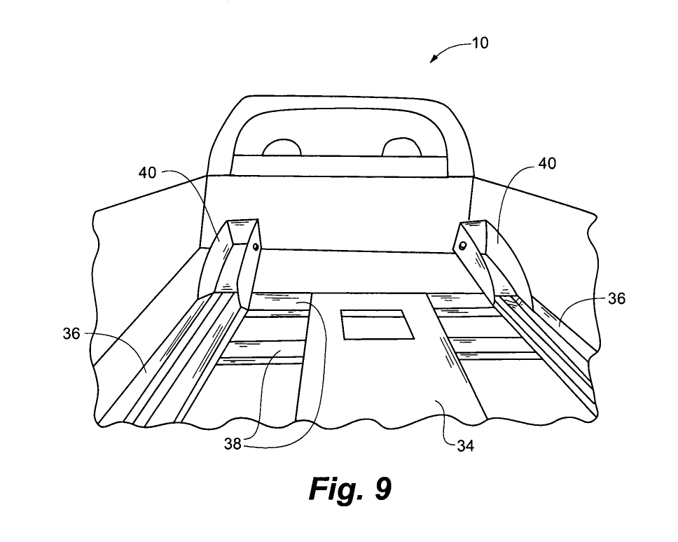

Next, a snowmobile is advanced towards the sled loader 10 while a rider directs the snowmobile ski tips towards the respective ski ramps 36 until the skis begin to climb upwardly on the ramp 14, as can be seen in FIG. 8. The speed of the snowmobile is maintained sufficient to allow the snowmobile ski tips to advance upwardly on the ski ramps 36 until the snowmobile track begins to climb the track ramp 34 and a momentum of the advancing snowmobile causes the ramp 14 to pivot upon the rollers 28 until the ramp 14 is substantially parallel with the side members 30 of the base 12. The momentum of the snowmobile then causes the snowmobile and ramp 14 to advance on the rollers 28 on both the trailing cross member 20b and forwardmost cross member 20a until the ramp 14 is at a forwardmost position or transport position within the truck bed 21. The ramp 14 at a forwardmost position or transport position within the truck bed 21, without a snowmobile, can be seen in FIG. 9. The ramp 14 at a forwardmost position or transport position within the truck bed 21, with a snowmobile, can be seen in FIG. 11.

In a preferred embodiment of the present invention, there are ramp rollers 28 on an underside of the ramp 14, preferably proximate the ski ramps 36, such that when the snowmobile momentum causes the ramp 14 to pivot upon the rollers 28, the ramp rollers 28 roll along the truck bed 21 until the ramp 14 is at a forwardmost position, or transport position, within the truck bed 21.

The present invention also relates to a method of manufacturing the sled loader 10. The method of manufacturing includes the steps of: forming a cross member 20 by bending a sheet of steel so that the cross member 20 comprises a first portion 22 having a bottom surface and a top surface and a second portion 24 depending from the first portion 22; forming side members 30; attaching the side members 30 to the cross members proximate the ends thereof by welding or using various fasteners such as rivets, bolts, or screws, such that the cross member 20 and side members 30 define a base 12 and the side members 30 define a base width; attaching a base roller mount 26 on the upper surface of the first portion, preferably by welding, and installing a roller 28 to the roller mount 26; forming a ramp 14 comprising a track ramp 34 and a pair of ski ramps 36, each of the ramp portions being formed by bending the sheet steel; and connecting the track ramp 34 and ski ramps 36 using a ramp cross member 38, by welding or using various fasteners such as rivets, bolts, or screws, to define a ramp 14 that is operably connectable with the base 12, such that the ski ramps 36 are on opposing sides of the track ramp 34.

In a preferred embodiment, the method of manufacturing a sled loader 10 includes attaching a ramp roller 52 on an underside the ramp 14. Further, the method of manufacturing includes forming a notch 39 along the length of the ski ramps 36 by bending the sheet steel. Also, the method of manufacturing includes attaching ski tip receivers 40 at forward margins of the ski ramps 36, forming retaining lips 35 on the track ramp 34 by bending the sheet steel, and forming retaining lips 37 on the ski ramps 36 by bending the sheet steel.

While the snowmobile loader 10 of the present invention has been depicted and described with respect to a pick-up truck bed 21, the snowmobile loader 10 of the present invention could also be used on a flat bed truck or standard or customized snowmobile trailer.

In addition, while the snowmobile loader 10 of the present invention has been depicted and described with respect to being used with a snowmobile, the loader 10 could be used to load and transport other recreational vehicles, such as jet skis, motorcycles, dirt bikes, and all-terrain vehicles, without departing from the scope of the invention. Also, while the snowmobile loader 10 of the present invention has been depicted and described as having a single ramp 14, more than one ramp 14 could be used, for example, where the loader 10 is being used to load and transport motorcycles or dirt bikes.

The present invention is not limited to the above-described preferred apparatus. Furthermore, it should be understood that, while particular embodiments of the invention have been discussed, this invention is not limited thereto as modifications may be made by those skilled in the art, particularly in light of the foregoing teachings. Accordingly, the appended claims contemplate coverage of any such modifications as incorporate the essential features of these improvements within the true spirit and scope of the invention.

What is claimed is:

1. A snowmobile loader for loading/unloading a snowmobile from a bed member of a truck, comprising:
a two component loader assembly providing for loading of the snowmobile by means of the momentum of a forwardly moving snowmobile, having;
a base member being disposable on a lowered tailgate of a truck and presenting a pivot, the pivot being at least one roller disposed at a distal end thereof; and
a ramp having a track portion and first and second ski portions, a respective ski portion being disposed on opposing sides of the track portion, the respective ski portions including respective tip receivers disposed at a forward margin of the ski portions the ramp being selectively engageable with the base member such that the ramp is pivotable with respect to the base member pivot between a ramp position and a transport position, the ramp having at least one forwardly disposed roller member for selectively engaging the bed member of the truck, the roller member being disengaged from the bed member of the truck when ramp is in the ramp position, the ramp being separate from and uncoupled with respect to the base member.

2. The snowmobile loader of claim 1, including:
the base member having a depending portion, such that when the base member is disposed on the lowered tailgate the depending portion is disposable in an aperture defined between a forward edge of the lowered tailgate and a trailing edge of the bed portion of the truck, in such disposition, the base member being restrained from shifting with respect to the tailgate;

3. The snowmobile loader of claim 2 wherein the base member further comprises a second depending portion, such that when the base member is disposed on the lowered tailgate the second depending portion is disposable adjacent a trailing edge of the lowered tailgate and, in such disposition, the base member being further restrained from shifting with respect to the tailgate.

4. The snowmobile loader of claim 2 wherein the base member includes a plurality upward directed roller members for translatably supporting the ramp.

5. The snowmobile loader of claim 1 wherein each of the respective tip receivers include means for securing the snowmobile with respect to the ramp when the ramp is in a transport position.

6. The snowmobile loader of claim 1 wherein the ski portions include a recess extending along a length of the ski portions, a portion of a snowmobile runner being ridable in the groove and being guided thereby.

7. The snowmobile loader of claim 6 wherein the recess is V-shaped.

8. The snowmobile loader of claim 1 further comprising means for selectively securing the ramp portion to the base member when the ramp is in the transport position.

9. A method of loading a snowmobile into a truck bed comprising:
providing a two component loader including a base member and a ramp;
disposing the sled loader base member on a upper surface of a lowered truck tailgate and engaging a forward portion of the ramp with a forward margin of the tailgate and providing a base member pivot;
disposing the ramp in an inclined ramp position depending from the base member by engaging a ramp trailing portion with a ground surface and engaging a forward portion of the ramp member with the base member pivot; and
advancing a snowmobile over the ground surface towards the ramp at a speed sufficient to allow the snowmobile to advance upwardly on the ramp and engage the ramp, imparting a momentum of the snowmobile to the ramp, translating the snowmobile and the ramp member relative to the base member and pivoting the ramp about the base member pivot into a disposition wherein the ramp member is in rolling engagement with the truck bed, and advancing the snowmobile and engaged ramp relative to both the base member and the truck bed until the snowmobile and engaged ramp are in a transport position within the truck bed.
